(19) United States
(12) Patent Application Publication
(10) Pub. No.: US 2018/0261348 A1
(43) Pub. Date: Sep. 13, 2018

(54) Neutron and proton generating processes

(71) Applicant: Andre Michaud, St-Jean-Baptiste (CA)

(72) Inventor: Andre Michaud, St-Jean-Baptiste (CA)

(21) Appl. No.: 15/756,982

(22) PCT Filed: Aug. 1, 2016
(86) PCT No.: PCT/CA2016/000201

§ 371 Date: Mar. 1, 2018

(30) Foreign Application Priority Data
Sep. 8, 2015 (GB) 1515910.6

(51) Int. Cl. G21G 1/10; G21G 1/12; G21G 4/02; G21G 7/00; H05H 3/06

(52) U.S. Cl. CPC G21G 1/10; G21G 1/12; H05H 3/06; G21G 7/00; G21G 4/02

(57) ABSTRACT

Neutron and proton generating processes consist in a thermal neutrons generation process arising in particular circumstances after destabilization of a coherent electrons beam wherein electrons have a minimum carrying-energy of 1.022 MeV; a thermal protons generation process arising in particular circumstances after destabilization of a coherent positrons beam wherein positrons have a minimum carrying-energy of 1.022 MeV; and a stochastically equal numbers of thermal protons and neutrons generation process arising in particular circumstances after destabilization of a coherent electromagnetic photons beam wherein photons have a minimum energy of 1.022 MeV. Large amounts of residual energy and metastable partons would be produced during each process.

This application is a National Stage Application of International Application No. PCT/CA2016/000201, filed Aug. 1, 2016, which claims the benefit of Great

Britain Request No. 1515910.6, filed Sep. 8, 2015.

### FIELD OF THE INVENTION

The present invention relates generally to particle physics, but more particularly to neutron and proton generating processes.

### BACKGROUND OF THE INVENTION

It is well established since the Blackett and Occhialini experiments at the beginning of the 1930's that any free moving electromagnetic photon of energy 1.022 MeV or more will destabilize when grazing a massive particle such as an atomic nucleus, and convert to a pair of massive particles, which are one electron and one positron, whose masses are each made of 0.511 MeV/ĉ2 of the mother photon energy. Any energy in excess of this total amount of 1.022 MeV is then expressed as translational energy, that causes both particles to move away from each other at a velocity related to this excess energy, a process that was named “materialization”.

The details of detection by Blackett and Occhialini of electron-positron pair production from radiation are described in a paper published at the Royal Society of London, Vol. 139, No. 839 (Mar. 3, 1933, pp. 699-726), titled: “Some Photographs of the Tracks of Penetrating Radiation”, and the article is available at the following link:

http://hep.ucsb.edu/courses/ph225a/blackettocchialini.pdf.

Moreover, a team led by Kirk McDonald confirmed with experiment #e144 carried out in 1997 at the Stanford Linear Accelerator (SLAC), that by converging two sufficiently concentrated photons beams towards a single point in space, one beam being made up of massless electromagnetic photons exceeding the 1.022 MeV threshold, massive electron/positron pairs were created without any atomic nuclei being close by.

The details of experiment #e144 are described in a paper published in Physical Review Letters, Phys. Rev, Lett. 79, 1626, titled “Positron Production in Multiphoton Light-by-Light Scattering”, and the article is available at the following link:

http://journals.aps.org/prl/abstract/10.1103/PhysRevLett.79.1626.

Also, an analysis of the manner in which Newton's non-relativistic kinetic energy equation K=(mv̂2)/2 can be converted to an electromagnetic form which can then be upgraded to relativistic status, reveals that the kinetic energy provided to accelerate an electron accumulates according to an electromagnetic structure identical to the possible internal structure of free moving electromagnetic photons.

The conversion procedure of equation K=(mv̂2)/2 to relativistic status and demonstration of the structural identity between acceleration induced electron kinetic energy and energy making up free moving electromagnetic photons is described in a paper published in the International Journal of Engineering Research and Development, Vol. 6, Issue 4 (March 2013), pp. 01-10, titled “From Classical to Relativistic Mechanics via Maxwell”, and the article is available at the following link:

http://ijerd.com/paper/vol6-issue4/A06040110.swf.

This particular document having an “swf” extension may not be easily accessible. The content of that document, however, formed part of Applicant's priority document GB1515910.6 filed Aug. 9, 2015 and is incorporated herein by reference.

The identity of structure between electrons carrying energy and free moving photons, the latter having been proved to be able to convert to electron-positron pairs when exceeding the 1.022 MeV threshold as previously stated, hints at the possibility that the carrying-energy of electrons could also be susceptible to be destabilized into converting to electron-positron pairs when this carrying-energy is made to reach or exceed the 1.022 MeV threshold in excess of the energy of the electron rest mass, if the right destabilizing circumstances are met. This possibility is analyzed in Sections X of a paper published in 2013 in the International Journal of Engineering Research and Development, Vol. 8, Issue 1 (July 2013), pp. 10-33, titled “Inside Planets and Stars Masses”, and the article is available at the following link:

http://ijerd.com/paper/vol8-issue1/B08011033.pdf.

Experiments carried out from 1966 to 1968 at the Stanford Linear Accelerator (SLAC) facility with high energy non-destructive scattering of electrons against the inner components of protons and neutrons allowed identifying two other elementary, charged and massive particles inside these nucleons. These inner components were found to be only marginally more massive than electrons and positrons. One of them was found to have a charge of ⅔ that of a positron and was named “up quark” and the other was found to have a charge of ⅓ that of an electron and was named “down quark”. The inner scatterable structure of protons was then confirmed to involve 2 up quarks and 1 down quark (uud), and the neutron, 1 up quark and 2 down quarks (udd). No other scatterable components were ever found to exist inside nucleons via non-destructive scattering.

One of the papers describing this discovery was published by M. Breidenbach et al. at the Stanford facility, SLAC-pm-650, August 1969, titled “Observed Behavior of Highly Inelastic Electron-Proton Scattering”, and the article is available at the following link:

http://www.slac.stanford.edu/pubs/slacpubs/0500/slac-pub-0650.pdf.

Also, extensive production of hadrons (mesons and baryons, including protons and neutrons) were confirmed in numerous experiments carried out with colliding beams of electrons and positrons at the colliding-beam SPEAR facility of the Stanford Linear Accelerator in the 1970's. The following paper published by G. Hanson et al. in Physical Review Letters, Phys. Rev. Lett. 35, 1609 (1975), titled “Evidence for Jet Structure in Hadron Production by e+ e− Annihilation”, describes the details of these experiments, and the article is available at the following link:

http://journals.aps.org/prl/abstract/10.1103/PhysRevLett.5.1609.

Such production of hadrons from scattering of electrons and positrons leads to the conclusion that there may exist optimal energy levels at which production of protons and neutrons could be maximized by means of such electrons and positrons interaction.

Since the particles being scattered during these experiments were exclusively electrons and positrons, the possibility came to light that the up and down quarks that make up the scatterable inner structure of protons and neutrons could somehow be electrons and positrons that have mutually captured in e+ e+ e− and e− e− e+ triads, with insufficient energy to escape mutual interaction, triads that could then have accelerated in very particular circumstances to end up as the up and down charged and scatterable inner quarks of nucleons, despite the slight differences in masses and charges between electron and down quark on one hand, and positron and up quark on the other hand, that would remain to be explained.

The theoretical mechanics of such production of protons and neutrons from accelerating triads of the two possible combinations of electrons and positrons, is described in a paper published in the International Journal of Engineering Research and Development, Vol. 7, Issue 9 (July 2013), pp. 29-53, titled “The Mechanics of Neutron and Proton Creation in the 3-spaces Model”, and the article is available at the following link:

http://www.ijerd.com/paper/vol7-issue9/E0709029053.pdf.

Of course, the immediate objection to the possible existence of such a process is that the Principle of conservation of energy absolutely precludes the possibility that three particles with mass 0.511 MeV/ĉ2, for a total initial mass of 1.533 MeV/ĉ2 could transform through acceleration into a mass of 938 MeV/ĉ2 without borrowing energy from its surroundings, a borrowing that experimental data clearly shows never occurred during the SPEAR facility experiments.

Analysis of all objections to the possible existence of such a process has been carried out, which reveals that energy increase during such a process could only be adiabatic in nature, and thus could be possible without violating the Principle of energy conservation. The paper detailing this analysis was peer-reviewed and accepted for publication in the Journal of Physical Mathematics, J Phys Math 2016, 7:2, titled “On Adiabatic Processes at the Elementary Particle Level”, and the article is available at the following link:

http://www.omicsonline.com/open-access/on-adiabatic-processes-at-the-elementary-particle-level-2090-0902-1000177.pdf.

As described in the paper previously mentioned, titled “The Mechanics of Neutron and Proton Creation in the 3-spaces Model”, the newly created energy made available by each such adiabatic nucleogenesis occurrence would amount to three bremmsstrahlung photons of ˜155 MeV each, for a total of ˜465 MeV of new energy that would be liberated as the final and stable proton or neutron gyroradius configuration is reached, which represents a stable adiabatically induced relativistic mass increase of 938−1.533=˜936.467 MeV/ĉ2, for a grand total energy gain of ˜1401.467 MeV, that is, ˜2.245E-10 Joules.

Since this amount of ˜936.467 MeV/ĉ2 energy/mass would then be permanently stabilized in this new least action electromagnetic equilibrium state, this newly created energy/mass would become available as new permanently usable energy in the form of mass. The number of such nucleogenesis occurrences required to amount to 1 joule of energy is 4.454 billion, which is well within the usual amounts of particles that are beamed in high energy accelerators in quite reasonable time frames. For example, the collision rate at the LHC accelerator easily reaches about 2.4 billion per minute.

### SUMMARY OF THE INVENTION

The main advantage of this invention is a controlled and steady production of neutrons and protons that can be used as part of processes to initiate and control fusion in hydrogen fusion reactors for electricity production, or provide controlled and steady supplies of thermal neutrons to be used as part of useful isotopes production processes.

Another benefit of this invention is using the massive particles and residual energy produced by these processes for the motorization of spacecrafts, by ejecting steady streams of newly created massive particles to provide continuous thrust, without the need to carry large quantities of propellant, and providing all of the energy required for craft operation.

Another advantage of this invention is using the residual energy in specifically designed plants to produce electricity by heating circulating fluids.

To this effect, the invention consists in a thermal neutrons generation process arising in particular circumstances after destabilization of a coherent electrons beam wherein electrons have a minimum carrying-energy of 1.022 MeV; a thermal protons generation process arising in particular circumstances after destabilization of a coherent positrons beam wherein positrons have a minimum carrying-energy of 1.022 MeV; and a stochastically equal numbers of thermal protons and neutrons generation process arising in particular circumstances after destabilization of a coherent electromagnetic photons beam wherein photons have a minimum energy of 1.022 MeV. Large amounts of residual energy and metastable partons are produced during each process.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. For example, in this field, there is the notion of anti-matter wherein all particles present in matter have their counterparts in antimatter. Therefore what applies to neutrons and protons also happens to antineutrons and antiprotons. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 Schematic illustration of a beam generating equipment for generating protons and neutrons from destabilizing photons each having 1.022 MeV energy, as per claims 5 and 6.

FIG. 2 Schematic illustration of a beam generating equipment for generating neutrons from destabilizing electrons each having 1.022 MeV carrying energy, as per claim 4.

FIG. 3 Schematic illustration of a beam generating equipment for generating protons from destabilizing positrons each having 1.022 MeV carrying energy, as per claim 4

### DETAILED DESCRIPTION

The scattering energies that caused some protons and neutrons to be produced during the 1970's SPEAR facility experiments ran into the 6 to 7 GeV range as documented in the paper titled “Evidence for Jet Structure in Hadron Production by e+ e−Annihilation” previously mentioned. But considering that for the 2 possible threesome electron-positron configurations considered to mutually capture and initiate the hypothesized irreversible adiabatic acceleration sequence, these particles need to have little or even no translational energy while being in very close proximity to each other for the process to be triggered, it appears that to maximize nucleon production during such processes, the scattering energy level must be kept as close as possible to the 1.022 MeV threshold carrying-energy for each electron, positron, or photon of the incoming beams being used, while taking care that the total scattering energy doesn't go under the 1.022 MeV energy threshold, which prevents pair production.

### PROTON AND NEUTRON GENERATION BY PHOTON DESTABILIZATION

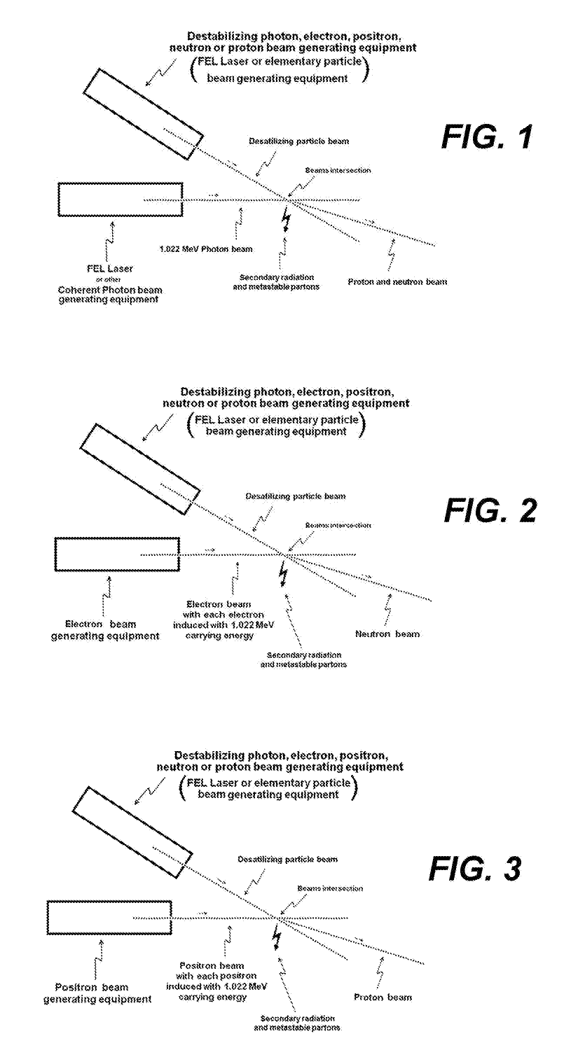

To produce protons an neutrons in stochastically approximate equal numbers, there is need to destabilize a coherent photon beam made of photons each minimally possessing 1.022 MeV of energy. The incoming photon beam may be generated by a FEL laser or other device able to generate coherent photon beams in the 1.022 MeV range (FIG. 1).

The required destabilizing factor that cause the 1.022 MeV photons of the incoming photon beam to destabilize is provided by a beam of elementary particles made of photons, electrons, positron, protons or neutrons or other particles that intersect the path of the incoming beam according to proximity, amount and velocity parameters configured to provide optimal output (see FIG. 1).

In the case of use of a 1.022 MeV incoming beam, both incoming beam and destabilizing beam have to be as tightly colimated as possible for the pairs to appear in sufficient numbers and proximity for the threesomes to form (see FIG. 1).

The incoming photon beam can be made of photons of less than 1.022 MeV energy photons, provided that the destabilizing beam contributes the required missing energy upon scattering.

The primary output of the intersection of both beams is a beam stochastically containing approximate equal numbers of protons and neutrons, and as secondary output, radiation energy and stray metastable partons amounting to approximately 465 MeV of new energy for each proton or neutron produced (see FIG. 1).

### Neutron Generation by Destabilization of Electron Carrying Energy

To produce neutrons from the destabilization of an incoming electron beam, each electron being induced with 1.022 MeV of energy, the destabilizing factor is provided by a beam of elementary particles made of photons, electrons, positron, protons or neutrons or other particles that intersect the path of the incoming electron beam according to proximity, amount and velocity parameters configured to provide for optimal output (see FIG. 2).

The decoupled electron-positron pair that appears as the 1.022 MeV electron carrier-photon decouples, is generated by structure in the immediate proximity of the carried electron, initiating the production of a thermal neutron initially devoid of translational energy, all of the incoming electron carrying-energy having been converted to mass.

The primary output of the intersection of both beams is a neutron beam, plus as secondary output, radiation energy and stray metastable partons amounting to approximately 465 MeV of new energy for each neutron produced (see FIG. 2).

### Proton Generation by Destabilization of Positron Carrying Energy

To produce protons from the destabilization of an incoming positron beam, each positron being induced with 1.022 MeV of energy, the destabilizing factor is provided by a beam of elementary particles made of photons, electrons, positron, protons or neutrons or other particles that intersect the path of the incoming positron beam according to proximity, amount and velocity parameters configured to provide for optimal output (see FIG. 3).

The decoupled electron-positron pair that appears as the 1.022 MeV positron carrier-photon decouples, is generated by structure in the immediate proximity of the carried positron, initiating the production of a thermal proton initially devoid of translational energy, all of the incoming positron carrying-energy having been converted to mass.

The primary output of the intersection of both beams is a proton beam, plus as secondary output, radiation energy and stray metastable partons amounting to approximately 465 MeV of new energy for each proton produced (see FIG. 3).

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. Processes for generating neutrons and protons.

2. A process for generating neutrons and protons as in claim 1 wherein protons and neutrons are generated by destabilization of elementary particles.

3. A process for generating neutrons and protons as in claim 2 wherein the elementary particles are photons.

4. A process for generating neutrons and protons as in claim 2 wherein the protons are produced by way of destabilization of positron carrying energy, and neutrons are produced by destabilization of electron carrying energy.

5. A process for generating neutrons and protons as in claim 1 wherein a coherent photon beam made of photons, each minimally possessing 1.022 MeV of energy, is destabilized by way of a beam of elementary particles, comprised of, but not limited to, photons, electrons, positron, protons, and neutrons that intersect the path of said incoming beam according to proximity, amount and velocity parameters configured to provide optimal output.

6. The process for generating neutrons and protons of claim 5 wherein said incoming photon beam is generated by a FEL laser able to generate coherent photon beams in the 1.022 MeV range.
